(19) United States
(12) Patent Application Publication
(10) Pub. No.: US 2020/0347306 A1
(43) Pub. Date: Nov. 5, 2020

(54) PROCESSING METHOD FOR RECYCLING WASTE AND PROCESSING SYSTEM FOR RECYCLING WASTE

(71) Applicant: OHGI TECHNOLOGICAL CREATION CO., LTD., Otsu-shi, Shiga (JP)

(72) Inventors: Takehiko OHGI, Otsu-shi (JP); Tatsuhiko OHGI, Otsu-shi (JP)

(73) Assignee: OHGI Technological Creation Co., Ltd., Otsu-shi, Shiga (JP)

(21) Appl. No.: 16/615,340

(22) PCT Filed: Oct. 3, 2018
(86) PCT No.: PCT/JP2018/036989

§ 371 Date: Nov. 20, 2019

(51) Int. Cl. C10B 53/07; B09B 3/00; C10B 41/00; C10B 57/02; C10B 25/16; C01B 32/324; C01B 32/336

(52) U.S. Cl. CPC C10B 53/07; B09B 3/0091; C10B 41/00; C01B 32/336; C10B 25/16; C01B 32/324; C10B 57/02

(57) ABSTRACT

The method and system for recycling waste including plastic waste of the present invention includes a carbonizing step in which waste including disused plastic products such as PET bottles is carbonized in a carbonization furnace in which the temperature is raised in stages multiple times.

### TECHNICAL FIELD

The present invention relates to a method and a system for recycling waste including disused plastic products such as PET bottles.

### BACKGROUND ART

Conventionally, various methods for recycling waste have been proposed (for example, see Patent Documents 1 to 3).

### RELATED ART DOCUMENT

### Patent Document

PATENT DOCUMENT 1: Japanese Unexamined Patent Application Publication No. H5-185056
PATENT DOCUMENT 2: Japanese Patent No. 4860363
PATENT DOCUMENT 3: Japanese Unexamined Patent Application Publication No. 2017-213899

### DISCLOSURE OF THE INVENTION

### Problems to be solved by the Invention

As a method for processing waste as disclosed in Patent Documents 1 to 3, there are methods such as incineration disposal or carbonization recycle. However, in recent years, there have been an increasing number of problems worldwide, such as marine pollution and adverse impacts on ecosystems, which have been caused by frequent illegal dumping of waste into the oceans as a result of difficulty in thorough separation and collection of plastic waste, and a shortage of processing facilities and failure in processing with the increase in plastic waste.

More specifically, it is estimated that the amount of plastic production since 1950 is about 8.3 billion tons, of which about 6.3 billion tons are dumped as plastic waste. It is estimated that such dumped plastic waste will remain in the ocean without decomposition even in millennia. In addition, it is estimated that the amount of plastic waste in the ocean is about 8 million tons per year, and the total amount of existing plastic waste in the ocean is estimated to be about 150 million tons.

In view of such circumstances, a method for recycling wastes such as those disclosed in Patent Documents 1 to 3 has been discussed and implemented, but the construction of a carbonization furnace facility for recycle requires a large initial cost, and the plastic waste included in the wastes is mixed with a thermoplastic resin and a thermosetting resin which differ greatly in the properties, and therefore, it is very difficult to carbonize the waste including plastic waste uniformly and evenly with good quality. In addition, not only plastic waste but also defective products such as industrial products and food generated in large quantities in factories, for example, are difficult to sort and dispose because various materials are mixed. However, it is expensive to dispose of the waste, and various laws such as the Waste Disposal Law, the Food Recycling Law, and the Containers and Packaging Recycling Law are required to be complied with. Therefore, how to dispose of such waste is a difficult problem to be addressed by enterprises.

The present invention has been proposed in view of the above circumstances, and an object thereof is to provide a processing method and a processing system for recycling waste, which are capable of uniformly and with good quality carbonizing and recycling waste including not only plastic waste but also waste including disused plastic.

### Means of Solving the Problems

In order to achieve the above object, the processing method for recycling waste of one aspect of the present invention has a carbonizing step of carbonizing waste including disused plastic products such as PET bottles, in a carbonization furnace in which the temperature is raised in stages multiple times.

The processing system for recycling waste of one aspect of the present invention is characterized in that the system has a carbonization apparatus for carbonizing waste including disused plastic products such as PET bottles, in the carbonization furnace in which the temperature is raised in stages multiple times.

### Effect of the Invention

According to the processing method and system for recycling waste of one aspect of the present invention, it is possible to carbonize waste including plastic waste which is difficult to process uniformly and with good quality and to recycle the carbonized waste.

### BRIEF DESCRIPTION OF THE DRAWINGS

FIG. 1A is a flow chart showing a basic procedure of the processing method (system) for recycling waste including plastic waste according to the first embodiment of the present invention. FIG. 1B is a graph for explaining control temperature in a carbonizing step.

FIG. 2 is a schematic structural diagram of a carbonization apparatus used in the processing method for recycling waste.

FIG. 3 is a conceptual diagram of a ranking step in the processing method (system) for recycling waste including plastic waste according to the second embodiment of the present invention.

FIG. 4 is a flow chart showing a basic procedure of the processing method (system).

FIG. 5 is a table with actual photographs respectively showing waste including the classified plastic waste after each step.

### MODE FOR CARRYING OUT THE INVENTION

Embodiments of one aspect of the present invention are described below with reference to the accompanying drawings.

First, a basic procedure of a processing method for recycling waste (hereinafter, simply referred to as a recycling method) and a basic configuration of a processing system for recycling waste 1 (hereinafter, simply referred to as a recycling system) are described.

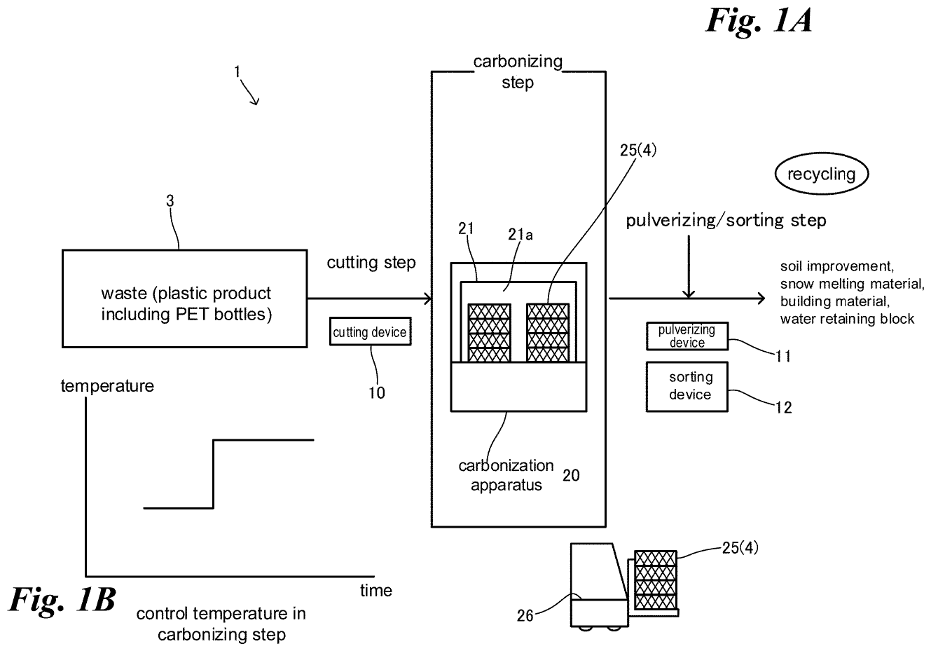

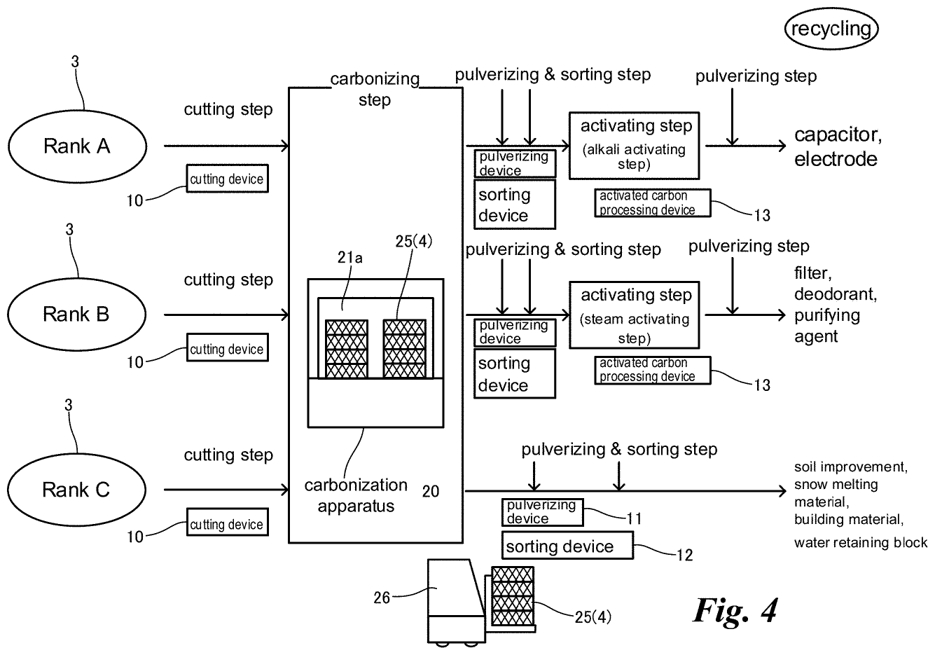

As shown in FIG. 1A, FIG. 1B, and FIG. 4, the present recycling method executes a carbonizing step of carbonizing waste 3 including disused plastic products (so-called plastic waste) such as PET bottles in a carbonization furnace in which temperature is raised in stages multiple times.

The recycling system 1 is a system for performing the recycling method, and includes at least a carbonization apparatus 20 for carbonizing waste 3 including disused plastic products such as PET bottles.

### First Embodiment

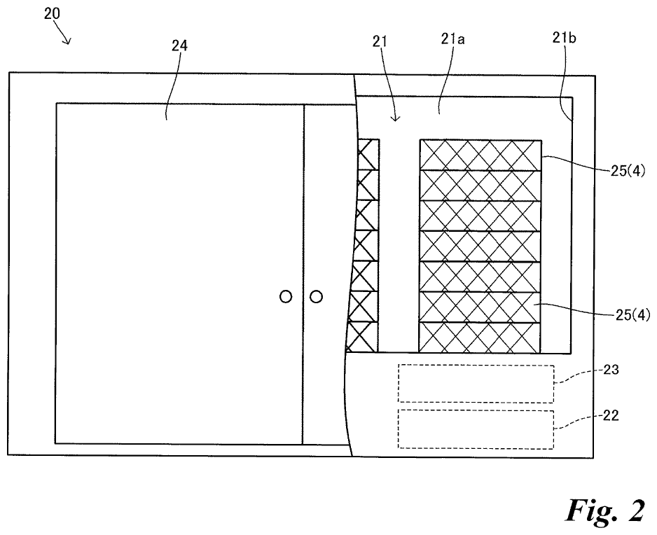

Next, the recycling method and the recycling system 1 according to the first embodiment shown in FIGS. 1 and 2 are described in detail.

<Recycling Method>

The recycling method includes at least a cutting step and a carbonizing step which are executed in order, and after the carbonizing step, a pulvelizing step of further pulverizing the carbonized waste to a predetermined particle size and a sorting step of removing inappropriate substances by passing the waste through a sieve are executed. Hereinafter, each step is described. Here, the recycling method including the cutting step is described as an example, but carbonization is possible without the following cutting step as long as the waste 3 includes plastic waste having a size of about 5 (being as big as a first) to 10 cm.

<Cutting Step>

The cutting step is a process of cutting the waste 3 being a raw material into flakes (thin pieces), tehreinafter referred to as a cut product, and is performed using a cutting device 10. The cutting device 10 is not particularly limited, and a known cutting device can be used. The size of the waste to be cut into flakes can be determined for each rank in another embodiment to be described later, but is not particularly limited in the present embodiment, and can be about 2 to 10 cm. The cut product 4 can be accommodated in a carbonization container 25 having a mesh-like side surface so as to be easily handled during carbonization.

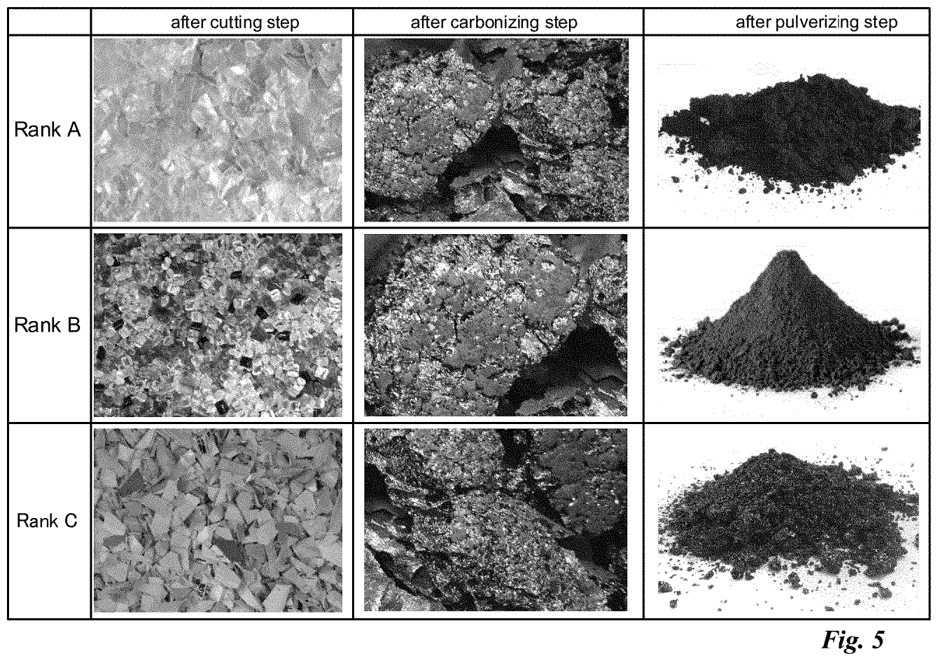

The cut product 4 thus cut and formed is accommodated in the carbonization container 25 and the carbonization container 25 is stacked in a carbonization furnace 21 of the carbonization apparatus 20 by using a forklift 26 (see FIG. 1A). It is preferable that the carbonization container 25 does not have an air layer formed between the cut products 4. This is because the smaller the number of air layers, the better the carbonization efficiency. The column “after the cutting step” in the table of FIG. 5 shows a photograph of the state of the waste including plastic waste after the cutting step.

<Carbonizing Step>

The carbonizing step is carried out using such a carbonization apparatus 20, and an example in which a batch-type heated steam carbonization apparatus is used as the carbonization apparatus 20 is described. In this case, the carbonization container 25 containing the cut product 4 needs only to be placed in a predetermined place of the carbonization furnace 21.

As described above, the carbonization of the cut product 4 is performed while the temperature in the carbonization furnace 21 is raised in stages. For example, as shown in FIG. 1B, the temperature can be raised in two stages.

As an example, a case of the carbonization furnace 21 capable of carbonizing the cut product 4 having a monthly production of 100 tons is specifically described. First, when a start button of the carbonization furnace 21 is turned on, a heating burner is started to heat the inside of the carbonization furnace 21 to 420 to 430 degrees Celsius. The temperature inside the carbonization furnace 21 is maintained at about 400 degrees Celsius. Then, the cut product 4 (carbonization container 25) is stored in the carbonization furnace 21 sealed in an oxygen-free state, heated for 100 to 160 minutes up to 500 to 550 degrees Celsius, and further heated for 30 to 50 minutes (see FIG. 1B). At this time, the heating burner for heating the carbonization furnace 21 is not particularly limited, but a burner fueled with kerosene or the like is employed. When a thermoplastic resin is included in the plastic waste included in the waste and is suddenly processed at a high temperature, it melts and disappears. On the other hand, when the waste includes a thermosetting resin, the waste is hardened and becomes a lump, so that it is difficult to obtain high-quality carbide. However, by raising the temperature in stages multiple times as described above, it is possible to obtain 20 tons per month of carbide, which is uniform and has good quality, by carbonizing the cut product 4 having a monthly production of 100 tons per kilometer. The column “after the carbonizing step” in the table of FIG. 5 shows a photograph of the state of the carbide carbonized by the above-described method.

Thereafter, in order to further decompose harmful substances such as dioxins, formaldehydes, phenolic resins, coal tars, and the like, the temperature can be raised to 750 to 850 degrees Celsius.

Further, microwave heating can be performed in addition to normal heating in the carbonization furnace 21. In this case, since the cut product 4 is heated from the inside when the microwave is radiated, the temperature rising speed is increased, and the processing time is shortened. Further, in this case, since the cut product 4 is heated from the inside by microwaves in addition to normal heating from the outside, it is possible to obtain uniform and even carbide high-quality.

In order to “carbonize” the plastic waste included in the waste, unlike the case in which ordinary waste is incinerated into “ash”, it is preferable to carry out carbonization in an oxygen-free state, but it can be in a low-oxygen state. Carbon dioxide is generated in the incineration, but carbon dioxide is scarcely generated and solid carbon is obtained in the anoxic or near-anoxic state.

The carbonization apparatus 20 is not particularly limited and can be a known carbonization apparatus having any functions as long as it can raise the temperature stepwise in, but a batch type heated steam type carbonization apparatus is described here. As shown in FIG. 2, the carbonization apparatus 20 has the carbonization furnace 21 in which the carbonization container 25 is stored in a stacked state, a heating section 23 for heating a carbonization furnace space 21a to carbonize the cut product 4, a control section 22 for controlling the heating section 23 so as to raise and maintain the temperature of the carbonization furnace space 21a to a predetermined temperature, and a sealing door 24 for sealing the interior of the carbonization furnace 21 to an oxygen-free state.

The carbonization furnace 21 has a closed structure, and has the carbonization furnace space 21a in which the carbonization container 25 is stored in a stacked state. In order to achieve nearly complete carbonization, it is desirable to have a sealed double structure system capable of blocking oxygen. The wall of the carbonization furnace 21 can be a metal furnace. In consideration of long-term use, at least an inner wall 21b side of the carbonization furnace 21 is desirably formed of a heat-resistant brick or a refractory brick having a heat resistance of, for example, 2000 degrees Celsius. Further, it is desirable to apply a heat-resistant paint to the inner wall 21b in order to use the carbonization furnace 21 for a long period of time.

The heating section 23 of the carbonization apparatus 20 is configured to use heated steam as a direct heating source, and the temperature of the carbonization furnace space 21a is kept constant by convection of heated steam. Due to such a convection effect, the temperature of the stored plural carbonization containers 25 (the cut product 4) is raised so as to keep stable temperature.

The control section 22 includes a CPU, a program, and the like, and raises and keeps the temperature of the carbonization furnace space 21a in cooperation with the heating section 23, a temperature detecting section (not shown), and the like.

The sealing door 24 is a door for sealing the interior of the carbonization furnace 21 in an oxygen-free state, and it is desirable to arrange a large door as shown in FIG. 2 so that a plurality of carbonization containers 25 can be put in and taken out by the forklift 26.

Since the carbonization apparatus 20 as described above has a sealed structure, oxygen is shut off, generation of carbon dioxide is suppressed, and carbonization purity is enhanced. In addition, since the carbonization apparatus 20 is batch type, such an apparatus is better in cost performance than a rotary type carbonization apparatus, and it is easier to increase the number of installations according to the throughput. When the carbonization container is shaken and carbonized, the carbonization process is carried out without solidification of waste. However, shaking is not necessary depending on the amount of waste to be carbonized at a time, and in any case, an agitation mechanism required for the rotary type is unnecessary, so that the cost of the apparatus itself (initial cost) is reduced. The carbonization apparatus 20 can be configured to use dry distillation gas generated by carbonization as thermal energy. Therefore, the running cost is reduced.

Here, in the example the carbonization container 25 housing the cut product 4 is placed in a predetermined place of the carbonization furnace 21 and carbonized, but it is needless to say that a simple swinging mechanism for swinging the carbonization container 25 can be added. In this case, it is possible to obtain uniform and even carbide with high-quality by mass treatment.

The carbonization apparatus can employ a swinging drum type carbonization furnace or a fluidized bed type carbonization furnace other than those described above. For example, in the case of a drum type carbonization furnace, carbonizing process is performed continuously by dividing the interior of the carbonization furnace into a plurality of zones, increasing the temperature in stages, and providing a blower fan and an air chamber. In these cases, the carbonizing process is performed continuously compared with the batch type described above, the swinging drum-type carbonization furnace is suitable for the case where the waste including a large amount of plastic waste is to be processed. The swinging drum type, unlike the fluidized bed type, to be described later, swings without rotating, so that it is possible to install the equipment in the periphery. Although not shown in the drawings, the waste heat generated in the processing step in the carbonization apparauts 20 can be recovered by a boiler, or a secondary combustion chamber for secondary combustion of the dry distilled gas generated from the carbonization apparatus 20 can be provided to construct a recombustion system.

After this carbonizing step, the carbide is taken out from the carbonization container 25, and then a pulverizing step of further pulverizing the carbide to a predetermined particle size and a sorting step of removing inappropriate substances by sieving are performed.

<Pulverizing Step>

In the pulverizing step, a pulverization device 11 for pulverizing carbide to a predetermined particle size is used. The carbide can be pulverized to, for example, 100 to 500 μm by using the pulverization device 11. In the column of “after the pulverizing step” in the table of FIG. 5, the state after the carbide is pulverized is shown as a photograph.

<Sorting Step>

In the sorting step, a sorting device 12 for removing inappropriate substances by sieving is used. The sorting device 12 is not particularly limited, and can be a vibrating sieve device, a magnetic sorting device, or the like.

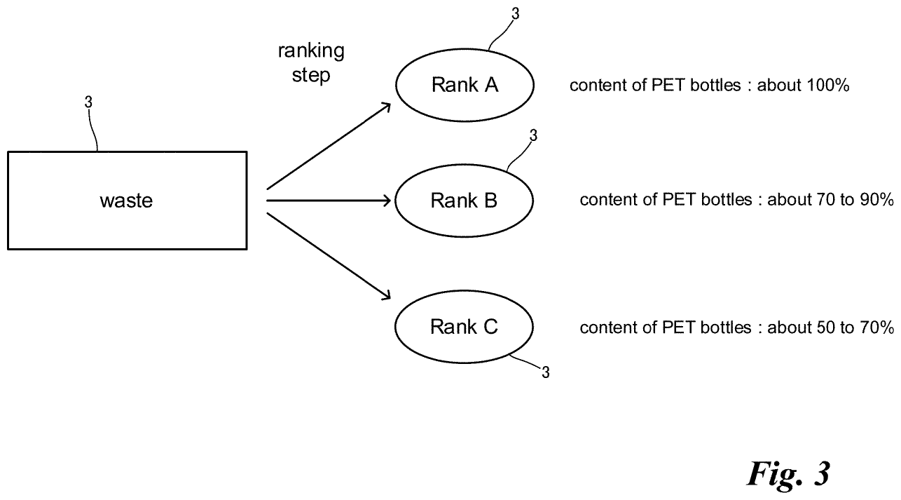

The pulverized carbide from which inappropriate substances are removed is used as a soil improvement material, a snow melting material, a building material, a water retaining block, or the like, similarly to the pulverized carbide of rank C, which is described in detail in the description of the embodiment shown in FIGS. 3 and 4. Conventionally, carbonization of not only plastic waste but also waste starts from 400 degrees Celsius or more, so that carbonizing process is usually performed by steaming and baking the waste in the carbonization furnace heated to 500 to 600 Celsius degrees or more in order to improve efficiency. In this case, although there is no problem with those which are easily carbonized, those which are hard to be carbonized are melted and solidified, and remain without being carbonized, which makes difficult to be recycled. Further, for example, in the case of a carbonization apparatus called a fluidized bed type, the waste is carbonized continuously, and therefore, as described above, it is preferable to process a large amount of waste. However, the fluidizing bed type uses a method of carbonizing the waste with humidified air while stirring the waste with fluidizing sand and a small amount of air in the carbonization furnace which rotates and has a cylindrical shape, and of recovering the powdered carbides at the upper portion of the carbonization furnace. Therefore, when the apparatus is increased in size, it is necessary to increase the size of the stirring mechanism, the rotating mechanism, the recovery mechanism, and the like, so that there is a concern that the apparatus is increased in cost. Also, the incomplete carbide is discharged from the bottom together with the fluidizing sand without being recovered, and therefore, it is disadvantageous that complete recycling of waste including plastic waste is not achieved. Furthermore, in the case of a large amount of processing, it is also important to carry out the carbonizing step while constantly stirring the waste so as not to form a large mass by the stirring mechanism.

It is demonstrated by various tests by the inventor of the present invention that the above-mentioned carbonization by increasing temperature in stages enables the waste 3 including plastic waste to carbonize uniformly and with good quality. According to the method described above, the waste including plastic waste is reduced by 20% by carbonization, e.g., about 30 tonnes of waste is converted to about 6 tonnes of carbide, and most of the carbide is able to be recycled.

In addition, since it takes time to raise the temperature in the furnace to a predetermined temperature depending on the size of the carbonization furnace, it is possible to efficiently perform the carbonizing step by providing a plurality of furnaces in which carbonization is completed by a time difference, and by adopting a replacement system. Further, when the waste 3 including the plastic waste is put into the carbonization apparatus 20 provided with the carbonization furnace 21 as described above, the carbonization apparatus 20 whose temperature is controlled is subsequently operated for a predetermined time, so that the carbonizing process is easily performed even by a user who does not have specialized knowledge. Therefore, if such an apparatus is introduced into a factory which has a trouble of disposing of the waste 3, the waste 3 including defective products generated in manufacturing is processed of so as to be recycled. The processing method and system for recycling the waste 3 in one aspect of the present embodiment are applied not only to a processing facility of a local government but also to a disposal processing system in a factory of a private company, for example. Especially, in the case of the batch type carbonization apparatus 20 described above, compared with the rotary type or the screw type, the installation area is small, the cost is easily reduced, the apparatus is capable of smokeless, and cooling water is unnecessary, so that the apparatus is applied to from a small-scale treatment to a large-scale treatment.

### Second Embodiment

Next, a recycling method and a recycling system according to the second embodiment shown in FIGS. 3 and 4 are described. FIG. 5 is a table with actual photographs respectively showing ranked waste including plastic waste after the ranking step in the recycling method of waste in the second embodiment.

In this recycling method, the cutting step, the carbonizing step, the pulverization step, and the sorting step are performed like the embodiment in FIG. 1, but before the cutting step, the ranking step of ranking waste into a plurality of ranks based on the PET bottle content is performed. The cutting step is described here as well, but it is the same as the first embodiment in that the cutting step can be omitted.

As shown in FIG. 3, the ranking step is for ranking waste including plastic waste into three ranks A, B, and C based on the content of PET bottles. The waste in the rank A has a PET bottle content of about 100%, the waste in the rank B has a PET bottle content of about 70 to 90%, and the waste in the rank C has a PET bottle content of about 50 to 70%. Such sorting can be performed manually or by a machine.

As shown in FIG. 4, the cutting step and the carbonizing step can be performed in order in the same manner as in the first embodiment as the recycling process of waste including plastic waste classified into the ranks. The cutting step can be carried out by using the cutting device 10 for each rank, and for example, the waste in the rank A is cut to about 0.5 to 3 mm, that in the rank B is cut to about 0.5 to 3 cm, and that in the rank C is cut to about 5 to 10 cm. The cutting dimension is not particularly limited. In the column “after the cutting step” of the table of FIG. 5, photographs of waste including plastic waste after cutting the waste in the rank A, B, and C are shown. As can be seen from FIG. 5, the waste in the rank A is composed of only a transparent PET bottle material because the content of PET bottles is about 100%. As can be seen from FIG. 5, since the content of the PET bottle is about 70 to 90%, the rank B includes mostly transparent PET bottles, but the presence of a colored plastic material is observed, and the rank B contains a mixture of a thermosetting resin and a thermoplastic resin. Further, as can be seen from FIG. 5, since the content of PET bottles in the rank C is about 50 to 70%, not only the plastic material other than the PET bottles, the thermosetting resin, and the thermoplastic resin are mixed, but also the presence of waste such as wood pieces, rubber, paper, and the like whose material are not able to be specified is seen.

After cutting the ranked waste including plastic waste, the carbonizing step is carried out by using the carbonization apparatus 20 for the waste in each rank. In the column of “after the carbonizing step” in the table of FIG. 5, the state of the carbide of the waste in the rank A, the rank B, and the rank C, respectively, is shown in a photograph. As described above, according to the recycling method of one aspect of the present embodiment, it is possible to obtain carbide which is so homogeneous as not to discern difference in appearance when viewed from a black-and-white photograph. As for the carbonizing step, as shown in FIG. 4, the waste in the carbonization container 25 for each rank can be carbonized while the carbonization container 25 for each rank is provided in the carbonization furnace 21 of the carbonization apparatus 20 in rows. Details of the cutting step and the carbonizing step (carbonization apparatus 20) are the same as those in the embodiment of FIG. 1, and therefore description thereof is omitted.

After the carbonizing step, the pulverizing step and the sorting step are performed in the same manner as in the embodiment of FIG. 1. In the pulverizing step, for example, the waste in the rank A can be pulverized to 5 to 8 μm, the rank B can be pulverized to 10 to 30 μm, and the rank C can be pulverized to 100 to 200 μm. In the column of “after the pulverization step” in the table of FIG. 5, the state after the pulverizing of the waste in the rank A, B, and C, respectively, is shown by photographs. The photograph of the rank A after the pulverizing step shows a very fine and homogeneous carbide (activated carbon). The photograph of the rank B after the pulverizing step also shows that the activated carbon is fine and homogeneous. The photograph of the rank C after the pulverizing step shows a whitish appearance because it is made black and white, but the whitish substances ares not impurities and the activated carbon is uniform.

Details of the pulverizing step (the pulverization device 11) and the sorting process (the sorting device 12) are the same as those in the embodiment of FIG. 1, and therefore description thereof is omitted.

The pulverized carbide after the sorting step is rendered into different steps depending on the rank. An activating step is performed for the rank A and the rank B, and the activating step can be performed for rank C, but it is unnecessary depending on the purpose of usage.

More specifically, an activated carbon having a specific surface area of 3,000 to 3,600 m²/g is formed by performing an alkali activating process in an activated carbon processing device 13 composed of a hybrid carbonization furnace using microwaves and heat. For the waste in the rank B, steam activation is performed in another activated carbonization apparatus 13, and activated carbon having a specific surface area of 500 to 1,000 m²/g is formed.

The activated carbon thus formed can be pulverized to a predetermined particle size using a pulverization device (not shown) such as a jet mill, depending on the purpose of recycling.

<Rank A>

The carbide in the rank A is activated carbon derived from polyethylene terephthalate including almost no substances other than PET bottles, and the carbide in the rank A with a particle size of 10 μm or less is used as activated carbon for an electrode material such as a rapid charge/discharge capacitor (EDLC) of an electric vehicle. The rapid charge/discharge capacitor is formed by coating activated carbon on the surface of a current collector such as an aluminum foil, and stores electricity on the surface. The activated carbon derived from polyethylene terephthalate has a large specific surface area, complicated pore structure, and a fear in response characteristics when the current density is increased. However, by setting the particle size to 10 μm or less, not only high discharge capacity but also good speed characteristics are achieved at the same time. The activated carbon of rank A is used not only as an electrode material of a fuel cell, but also as a catalyst of high performance, an adsorbent of a harmful substance, and a yarn of a high function fiber.

<Rank B>

The carbide in the rank B is activated carbon having a substance other than PET bottles by about 10 to 30%, and is used for filters of air conditioners, automobiles, deodorants, purifying agents, and the like by setting the particle size into 10 to 30 μm or less. A porous sheet is used as the filter body, and the filter is formed by containing activated carbon in the sheet. Micropores are formed in the activated carbon, and various odor components are adsorbed and decomposed if artificial enzymes having the function of oxidizing the odor components with active oxygen and of converting the odor components into other substances are stored in the micropores.

<Rank C>

Conventionally, the waste in the rank C including large amounts of impurities other than PET bottles is subject to landfill or dumping, has a serious environmental problem. However, even if the the pulverized carbide in the rank C in the present embodiment includes substance other than PET bottles by about 30 to 50%, the carbide in the rank C is uniform and has good quality, and thus the carbide in the rank C is used as a soil improvement material, a snow melting material, a building material, a water retaining block, or the like. As a soil preservation/improvement material, pulverized carbide can be mixed in a volume ratio of about 10%. Thereby, clay and hard soil is made soft, and water permeability and water retention of the soil are improved. In addition, since the soil is made alkaline soil, it has been clarified by the experiment of the inventor that if agricultural crops, flowers, and grass are grown in this soil, the growing condition becomes good. Moreover, such alkaline soil is suitable for organic cultivation because soil bacteria are easily fixed, and is effective as a measure against acid rain and soil flow, and therefore, it is said that this alkaline soil is epoch-making as an effective use of waste including plastic waste which had to be landfilled or dumped in the past. As the snow melting material, for example, the carbide solidified in a block shape is arranged on a road surface or on a roof as a tile, whereby the carbide is used as a snow melting road or a snow melting tile in cold districts by using heaters or sunlight due to the heat conduction diffusion action of carbides. In addition, experiments by the inventors have shown that, if blocks including pulverized carbide in the rank C are laid in waterways and rivers, the carbide adsorbs nitrogen, phosphorus, and the like, and microorganism settled in the water decomposes harmful substances, thereby purifying the water. As described above, the carbide in the rank C obtained from waste including low-purity plastic waste is effectively utilized for various applications without being discarded.

As described above, according to the recycling system 1 and the recycling method according to the embodiment described above, waste including plastic waste is carbonized efficiently, and carbide is effectively utilized, thereby contributing to the solution of illegal dumping and marine pollution, which have been regarded as social problems in recent years. In addition, since waste with a low rank, in which many substances other than plastic waste are mixed, is also effectively recycled, it is possible to aim at zero waste including plastic waste.

### DESCRIPTION OF THE REFERENCE NUMBER

1 processing system for recycling waste
3 waste including plastic waste
4 cut product
10 cutting device
11 pulverization device
12 sorting device
13 activated carbon processing device
20 carbonization apparatus
21 carbonization furnace
21a carbonization furnace space
21b inner wall
22 control section
23 heating section
24 sealing door
25 carbonization container
26 forklift

1. A processing method for recycling waste, the processing method comprising:
a carbonizing step in which waste including disused plastic products such as PET bottles, is carbonized in a carbonization furnace in which the temperature is raised in stages multiple times.

2. The processing method for recycling waste according to claim 1, the processing method further comprising:
a ranking step for classifying the waste into a plurality of ranks based on PET bottle content before the carbonizing step.

3. The processing method for recycling waste according to claim 1,
wherein in the carbonizing step, the waste is stored in the carbonization furnace that is heated and maintained at a temperature of about 400 degrees Celsius and that is sealed in an oxygen-free state;
wherein the waste is further heated by raising temperature in the carbonization furnace into 500 degrees Celsius to 550 degrees Celsius; and
wherein the heated waste is carbonized by a heated steam method.

4. The processing method for recycling waste according to claim 1, the processing method further comprising:
a pulverizing step of further pulverizing the carbonized waste to a predetermined particle size after the carbonizing step; and
a sorting step of removing an inappropriate substance by sieving.

5. The processing method for recycling waste according to claim 2, the processing method further comprising:
an activation step in which alkali activation or steam activation is further performed for the waste classified into a rank having a high PET bottle content, thereby producing activated carbon.

6. A processing system for recycling waste, the processing system comprising:
a carbonization apparatus for carbonizing waste including disused plastic products such as PET bottles in a carbonization furnace in which the temperature is raised in stages multiple times.

7. The processing system for recycling waste according to claim 6, the carbonization apparatus comprising:
a carbonization furnace space in which a container having a mesh-like side face is stored in a stacked state so as not to generate an air layer between wastes;
a heating section for heating the carbonization furnace space and carbonizing the wastes;
a control section for controlling the heating section so as to raise and maintain the temperature of the carbonization furnace space to a predetermined temperature; and
a sealing door for sealing the interior of the carbonization furnace in order to make the interior of the carbonization furnace free of oxygen.

8. The processing system for recycling waste according to claim 6, the processing system comprising:
a pulverization device for pulverizing carbide carbonized by the carbonization apparatus to a predetermined particle size; and
a sorting device for removing inappropriate substances by sieving the carbide.

9. The processing system for recycling waste according to any claim 6, the processing system comprising:
an activated carbon processing device for alkali activation or steam activation of carbides classified in a rank having a high PET bottle content among carbides carbonized by the carbonization apparatus.

10. The processing method for recycling waste according to claim 2,
wherein in the carbonizing step, the waste is stored in the carbonization furnace that is heated and maintained at a temperature of about 400 degrees Celsius and that is sealed in an oxygen-free state;
wherein the waste is further heated by raising temperature in the carbonization furnace into 500 degrees Celsius to 550 degrees Celsius; and
wherein the heated waste is carbonized by a heated steam method.

11. The processing method for recycling waste according to claim 2, the processing method further comprising:
a pulverizing step of further pulverizing the carbonized waste to a predetermined particle size after the carbonizing step; and
a sorting step of removing an inappropriate substance by sieving.

12. The processing method for recycling waste according to claim 3, the processing method further comprising:
a pulverizing step of further pulverizing the carbonized waste to a predetermined particle size after the carbonizing step; and
a sorting step of removing an inappropriate substance by sieving.

13. The processing method for recycling waste according to claim 3, the processing method further comprising:
an activation step in which alkali activation or steam activation is further performed for the waste classified into a rank having a high PET bottle content, thereby producing activated carbon.

14. The processing method for recycling waste according to claim 4, the processing method further comprising:
an activation step in which alkali activation or steam activation is further performed for the waste classified into a rank having a high PET bottle content, thereby producing activated carbon.

15. The processing system for recycling waste according to claim 7, the processing system comprising:
a pulverization device for pulverizing carbide carbonized by the carbonization apparatus to a predetermined particle size; and
a sorting device for removing inappropriate substances by sieving the carbide.

16. The processing system for recycling waste according to claim 7, the processing system comprising:
an activated carbon processing device for alkali activation or steam activation of carbide classified in a rank having a high PET bottle content among carbides carbonized by the carbonization apparatus.

17. The processing system for recycling waste according to claim 8, the processing system comprising:
an activated carbon processing device for alkali activation or steam activation of carbide classified in a rank having a high PET bottle content among carbides carbonized by the carbonization apparatus.
